(19) United States
(12) Patent Application Publication
(10) Pub. No.: US 2007/0073542 A1
(43) Pub. Date: Mar. 29, 2007

(54) Method and system for configurable allocation of sound segments for use in concatenative text-to-speech voice synthesis

(75) Inventors: Hari Chittaluru, Boca Raton, FL (US); Wael M. Hamza, Yorktown Heights, NY (US); Brennan D. Monteiro, Boca Raton, FL (US); Maria E. Smith, Davie, FL (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/234,690

(22) Filed: Sep. 23, 2005

(51) Int. Cl. G10L 13/08

(52) U.S. Cl. 704/260

(57) ABSTRACT

Embodiments of the present invention provide a method, system and computer program product for synthesizing concatenative speech by allocating speech segments based upon their frequency of access during speech synthesis and storing frequently used speech segments in memory where they can be easily and quickly accessed. Speech data is recorded in separate files from which individual speech units are identified. The method and system of the present invention analyzes the frequency of access of each speech unit during synthesis and uses this data to sort the speech units according to their frequency of access. Those speech units that are accessed more frequently than others are loaded into memory where they can be accessed quickly during subsequent speech synthesis. Other speech units that are not used as frequently can be stored on a data storage disk. The invention can also dynamically adapt to changes in the frequency of speech unit access by moving units from memory to disk or vice versa depending upon their frequency of access or to account for a change in the user's system requirements.

### BACKGROUND OF THE INVENTION

1. Field of the Invention

The present invention relates to text-to-speech systems and more specifically to a method and system of creating concatenative text-to-speech voices that can be customized to a particular user's memory requirements by taking into account voice segment usage frequency.

2. Description of the Related Art

Text-to-speech (TTS) engines are well-known in the art. Typically, a TTS engine can be used to convert computer recognizable text to synthesized speech, which can be transmitted to an external audio device for ultimate audible presentation to a listener. Specifically, TITS technology permits users to audibly play back documents and provides applications with the ability to read information to the user. Whether running on a desktop computer, a telephony network, over the Internet, or in an automobile, the increased functionality of TTS-enabled applications can provide users with information access anytime, anywhere with almost any device.

A text-to-speech (“TTS”) engine is composed of two parts: a front end and a back end. The front end takes input in the form of text and outputs a symbolic linguistic representation. The back end takes the symbolic linguistic representation as input and outputs the synthesized speech waveform. The front end takes the raw text and converts things like numbers and abbreviations into their written-out word equivalents. This process is often called text normalization. Phonetic transcriptions are then assigned to each word, and the text is divided into various prosodic units, like phrases, clauses, and sentences. This process is often referred to as text-to-phoneme (TTP) or grapheme-to-phoneme (GTP) conversion. The back end of the TTS engine takes the symbolic linguistic representation and converts it into actual sound output in the form of synthesized speech. The back end of the TTS engine is often referred to as the synthesizer.

There are two types of synthesized speech, parametric (or electronic) speech synthesis and concatenative speech synthesis. Parametric speech synthesis involves recording electronic tones at specific frequencies matching vibrating vocal cords, and all its harmonics. Thus, a parametric speech synthesizer contains electronic circuitry that simulates the parameters of human speech sounds. By contrast, concatenative synthesis is based on the concatenation (or stringing together) of units of recorded speech. Concatenative speech synthesizers have as its units of synthesis, digitized human speech recordings. The job of the concatenative speech synthesizer is to arrange these units into a desired output, adjust the prosody (the metrical structure of speech, i.e. the pitch, length and stress of the phonetic segments), and to separate boundaries between the units in order to facilitate articulation.

In a TTS engine based upon concatenative synthesis, the number of recorded speech units needed depends upon each user's specific application. Users that desire enhanced speech quality in their applications require a larger concatenative text-to-speech (“CTTS”) voice, i.e. a voice with a large pool of audio units to choose from. Users with insufficient resources to support a large CTTS voice and who don't require the enhanced speech quality can choose to have audio units removed from a full, unpreselected voice pool. Thus, it is difficult to design a CTTS engine that satisfies all users, given the wide range of requirements.

Attempts have been made to provide a single CTTS engine that satisfies all types of user applications. Customized products can be developed that include voices of different sizes, but the cost of producing these types of systems is prohibitive since they require the development, packaging and maintenance of voices in all the sizes that satisfy all potential user requirements. Designers can produce CTTS systems that have smaller voices that would satisfy most users, but sacrifices quality for users that are capable of supporting a large voice footprint. Another attempt at solving the problem is for the CTTS engine designer to deliver a system of unpreselected voice size and store the voice on a disk during synthesis. However, this significantly reduces performance since disk access is typically slow.

User requirements are a major factor in determining what size voice to include in a CTTS product. Because user requirements vary greatly, a system is needed that can provide a user with a customized CTTS product, taking into account the user's voice pool requirements, data storage and maintenance capabilities, and overall system performance.

### BRIEF SUMMARY OF THE INVENTION

The present invention addresses the deficiencies in the art with respect to the tradeoff between CTTS voice size and synthesis quality and provides a novel and non-obvious method and system for maintaining statistical records of recorded speech unit usage in a concatenative text-to-speech processing model, and using these statistics to sort the recorded speech units according to their frequency of use. Those speech units that are accessed more frequently during speech synthesis are stored in memory where they may be quickly accessed. Speech units that are not used as often are stored on disk or another data storage device.

According to one aspect of the invention, a method of dynamically allocating speech segments used in a concatenative text-to-speech engine is provided. The method includes determining the memory capacity of a user computer adapted for playing a CTTS voice, where the user's computer includes a data storage unit, sorting the speech segments according to their frequency of access during speech synthesis, and partitioning the speech segments between the computer memory and the computer's data storage unit depending upon their frequency of access during speech synthesis.

According to another aspect of the invention, a computer program product having a computer usable medium with computer usable program code is provided. The code is for dynamically allocating speech segments used in a concatenative text-to-speech engine. The computer program product includes computer usable program code for determining memory capacity of a user computer adapted for playing of a CTTS voice, wherein the user computer includes a data storage unit, code for sorting the speech segments according to their frequency of access during speech synthesis, and code for partitioning the speech segments between the computer memory and the computer's data storage unit depending upon their frequency of access during speech synthesis.

According to yet another aspect of the invention, a system for dynamically allocating speech segments used in a concatenative text-to-speech engine is provided. The system includes a computer, the computer having a memory unit and a data storage unit adapted to store at least one file containing a plurality of speech segments, and a processor for sorting the speech segments based upon their frequency of access during speech synthesis. The processor is adapted to allocate the frequently used speech segments to the memory unit.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 illustrates the components of a typical text-to-speech engine adapted to incorporate an embodiment of the present invention;

FIG. 2 is a block diagram illustrating a computer incorporating an embodiment of the present invention;

FIG. 3 illustrates a sample set of speech units of a CTTS voice incorporating an embodiment of the present invention;

FIG. 4 is a flowchart illustrating the storing of speech units according to their frequency of access using an embodiment of the present invention;

FIG. 5 is a flowchart illustrating the partitioning of speech units incorporating an embodiment of the present invention; and

FIG. 6 is a flowchart illustrating the re-allocation of speech units incorporating an embodiment of the present invention.

### DETAILED DESCRIPTION OF THE INVENTION

Embodiments of the present invention provide a method and system for synthesizing concatenative speech by allocating speech segments based upon their frequency of use and storing frequently used speech segments in memory where they can be easily accessed. One embodiment of the present invention allows a TTS engine developer to design a CTTS voice of one size and customize it to a customer's memory footprint requirements without having to develop voices of different sizes for each customer and without degrading the synthesis quality. Training speech data is recorded as a set of separate audio files from which individual speech units are identified. Those speech units used more frequently than others are loaded into memory where they can be accessed quickly. Other speech units that are not used as frequently can be stored on a data storage disk. Notably, the invention can dynamically adapt to changes in speech unit use, and move units from memory to disk and vice versa depending upon their frequency of use.

Referring now to the drawing figures in which like reference designators refer to like elements there is shown in FIG. 1 a system constructed in accordance with the principles of the present invention and designated generally as “100”. System 100 illustrates a typical text-to speech model, which can be adapted to incorporate the present invention. In a typical concatenative speech engine, text 102 is converted into a series of electronic symbols 106 that represent sounds in the language of the speech synthesizer 108. The conversion is performed by a text-to-speech processor 104. The synthesizer 108 recognizes each electronic symbol, searches through its database of stored speech units and converts the electronic symbol to its sound equivalent, thus forming an audio representation, i.e. speech 110 of text 102.

In certain instances, a customer will request a large CTTS voice that contains many speech units. Or, a customer may not have the need for so many speech units and will request a smaller voice. This may be due to financial considerations or due to the customer's limited data storage constraints. The present invention examines text representative of that which is to be processed for speech, and determines which speech units are used more frequently. Using this information, the system of the present invention sorts the speech units according to the usage frequency and partitions the audio data so that the more frequently used sounds are stored in memory where they can be quickly retrieved, while sounds used less frequently are stored in a data storage file.

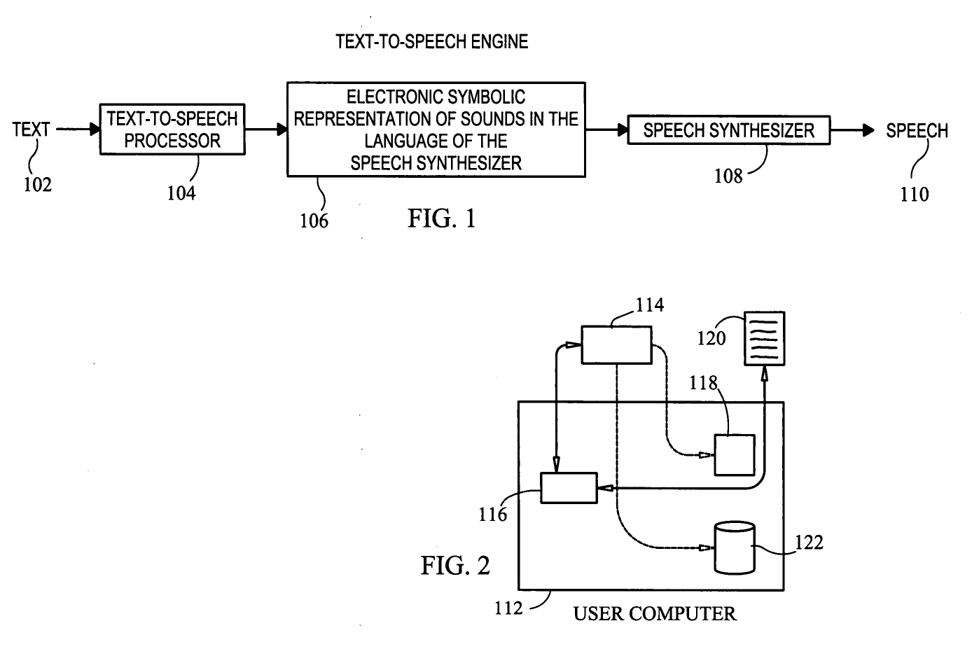

In FIG. 2, a system incorporating the present invention is shown. The system is preferably comprised of computer 112 including a central processing unit (CPU) 116, one or more volatile or non-volatile memory devices 118, data storage devices 122, input and output devices, display units and associated circuitry, controlled by an operating system and/or one or more application software programs. CPU 116 can be comprised of any suitable microprocessor or other electronic processing unit, as is well known to those skilled in the art. The various hardware requirements for the computer system as described herein can generally be satisfied by any one of many commercially available high speed multimedia personal computers. In addition to personal computers, the present invention can be used on any computing system which includes information processing and data storage components, including a variety of devices, such as handheld PDAs, mobile phones, networked computing systems, etc. Indeed, the present invention provides a development tool to be used in conjunction with any system employing a concatenative text-to-speech application.

Processor 116 gathers the usage statistics by examining representative text 120, generates the sequence of required phonemes and their attributes, searches the CTTS voice 114 for the best matching speech units, and updates the usage count of the selected speech units in a statistics storage file, which could be a file within disk 122 or another data storage device, either within computer 112 or in a remote location. The computer's processor 116 contains the required instructions to determine which of the speech units in CTTS voice 114 should be stored in memory and which files should be stored on disk 122, based upon the frequency statistics stored in the statistics storage file The most frequently used speech units are stored in memory 118 where they can be accessed quickly. The less frequently used speech units are stored on disk 122 or other type of data storage device.

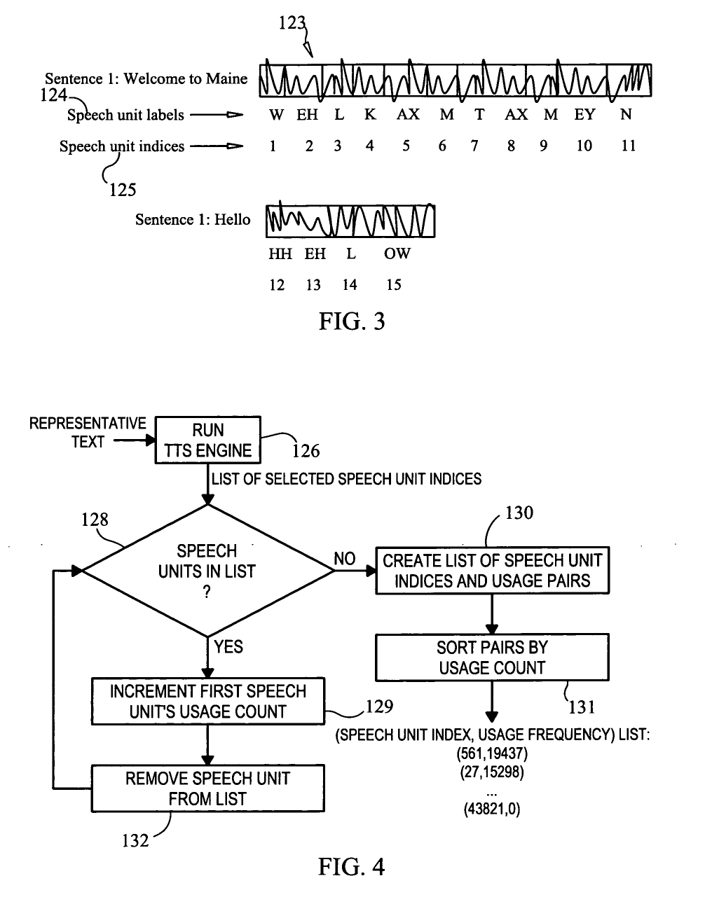

FIG. 3 shows a sample set of speech units of a CTTS voice. Each unit consists of audio 123, a label 124, and an index 125, where the index uniquely identifies the speech unit. In this example, the CTTS voice was built with recordings of “Welcome to Maine”, “Hello”, etc. The boundaries of each speech unit are identified, a label 124 is assigned specifying the type of sound, e.g., the phoneme, and an index 125 is assigned that uniquely identifies the speech unit.

FIG. 4 illustrates how the present invention sorts its speech units according to their frequency of use. A large corpus of text is synthesized at step 126, which results in a sequence of speech units being selected for producing the resulting synthesized speech. This list of speech unit indices is processed at step 128, and if there are speech units remaining, the statistics for each unit on the list is updated at step 129, and each unit removed from the list, via step 132. After all units on the list are processed, a table consisting of speech unit indices and usage is created at step 130 and sorted by usage by step 131. As described above, this sorted list allows for the simple splitting of the audio data into two portions based upon the computer's memory storage capacity.

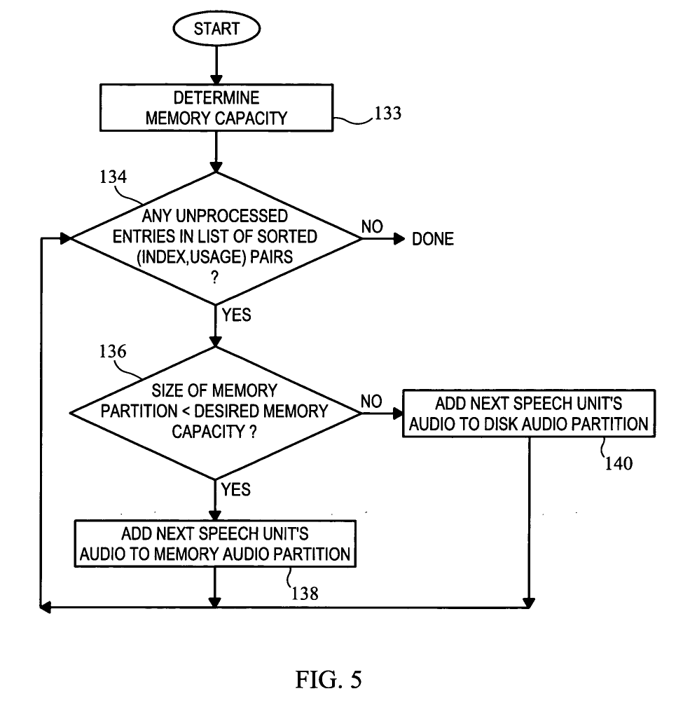

FIG. 5 illustrates the steps taken by the present invention in order to divide the speech units into two separate categories, those that are “more frequently” required, and those that are “less frequently” required, and to subsequently store the speech units in an appropriate medium. Prior to determining where the speech units are to be stored, the memory capacity of the user's computer 112 must be determined, via step 133. By determining the capacity of memory 118, the system can determine the subset of the speech units that may be allocated to memory. The list of speech unit indices and usage pairs is processed in sorted order via step 134. A memory partition point is designated and the processor determines if the memory partition point is less than the desired memory capacity, at step 136. If this is the case, the audio for the speech units in the list is added to the memory audio partition, at step 138. Once the desired memory partition size has been achieved, the audio for the remaining speech units are added to the disk audio partition, at step 140.

Because the efficiency of a memory-disk partition of the audio data is text-dependent, the present invention is adapted to dynamically alter the memory-disk speech unit allocation scheme by gathering statistics of speech unit usage during run time. By recalculating speech unit usage, a new memory-disk partition of the speech units may be used to replace the existing one. This results in a more efficient CTTS voice because it will require fewer disk accesses.

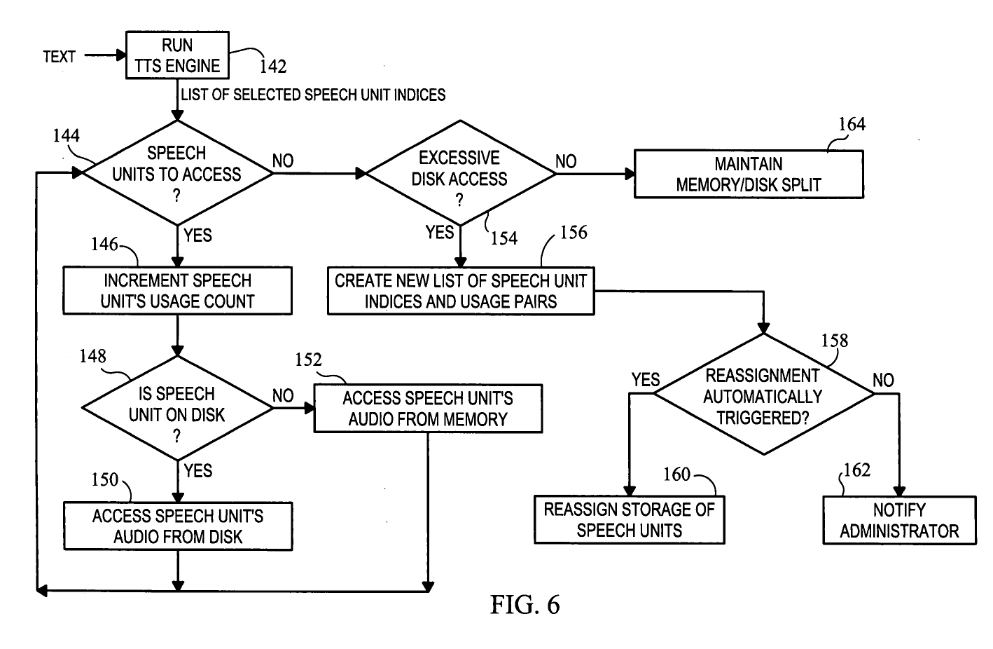

FIG. 6 illustrates how the invention dynamically adapts to the scenario where speech units that were previously only occasionally used are now required more frequently. In one embodiment, after the text-to-speech engine runs and text is synthesized at step 142, it is determined if there are additional speech units to access, at step 144. If there are, the usage count of each selected unit is updated, at step 146. If the speech unit resides on a disk (or other data storage device), determined by step 148, the audio representation of that speech unit is accessed from disk, at step 150. If the speech unit is not stored on disk, but rather in memory, the speech unit's audio is accessed from memory, at step 152. The speech units can then be sorted in the manner described above, likely resulting in a new allocation of speech units.

In an alternate embodiment, the system can determine if after running the CTTS engine, certain speech units that had been stored on disk were accessed excessively, via step 154. The determination of “excessive use” can be accomplished by means known in the art, typically involving comparing the number of times a speech unit was accessed from disk and comparing this number to a pre-established threshold value. If it is found that there has been excessive use of certain speech units, a new list of speech unit indices is created at step 156 and those speech units that were accessed excessively are re-allocated to memory, via step 160. Conversely, speech units that are originally stored in memory, but are no longer used frequently, may be relocated to disk storage. Reassignment of the speech units can be done automatically, via step 158, through a set of instructions stored on processor 116, or manually, when an administrator responds to the notification at step 162. If no speech units exceed the pre-determined threshold amount, then the previous memory-disk allocation is maintained, via step 164.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

What is claimed is:

1. A method of dynamically allocating speech segments used in a concatenative text-to-speech engine, the method comprising:
determining memory capacity of a user computer adapted for playing a CTTS voice, wherein the user computer includes a data storage unit;
sorting the speech segments according to their frequency of access during speech synthesis; and
partitioning the speech segments between the computer memory and the data storage unit depending upon their frequency of access during speech synthesis.

2. The method of claim 1, wherein partitioning the speech segments between the computer memory and the data storage unit includes:
establishing a frequency usage cutoff value; and
loading into computer memory the speech segments having a frequency of use greater than the frequency usage cutoff value.

3. The method of claim 1, wherein if speech segments stored in the data storage unit are accessed frequently during speech synthesis, re-allocating to computer memory the frequently accessed speech segments.

4. The method of claim 3, wherein re-allocating to computer memory the frequently accessed speech segments is performed automatically.

5. The method of claim 3, wherein re-allocating to computer memory the frequently accessed speech segments is performed manually.

6. The method of claim 1, wherein partitioning the speech segments between the computer memory and the data storage unit depending upon their frequency of use comprises:
assigning a time offset value for each speech segment, the time offset value corresponding to the average time between speech segment access occurrences;
determining a partition cutoff value; and
comparing the time offset associated with the speech segment with the partition cutoff value, such that if the time offset value of the speech segment is greater than the partition cutoff value, partitioning the desired speech segment in the data storage unit, otherwise partitioning the desired speech segment in the memory unit.

7. The method of claim 2, wherein the frequency usage cutoff value is related to the capacity of the computer memory.

8. A computer program product comprising a computer usable medium having computer usable program code for dynamically allocating speech segments used in a concatenative text-to-speech engine, said computer program product including:
computer usable program code for determining memory capacity of a user computer adapted for playing of a CTTS voice, wherein the user computer includes a data storage unit;
computer usable program code for sorting the speech segments according to their frequency of access during speech synthesis; and
computer usable program code for partitioning the speech segments between the computer memory and the data storage unit depending upon their frequency of access during the speech synthesis.

9. The computer program product of claim 8, wherein said computer usable program code for partitioning the speech segments between the computer memory and the data storage unit includes:
computer usable program code for establishing a frequency usage cutoff value; and
computer usable program code for loading into computer memory the speech segments having a frequency of use greater than the frequency usage cutoff value.

10. The computer program product of claim 8, further comprising computer usable program code for re-allocating to computer memory the frequently accessed speech segments if speech segments stored in the data storage unit are accessed frequently during speech synthesis.

11. The computer program product of claim 10, wherein said computer usable program code for re-allocating to computer memory the frequently accessed speech segments comprises computer usable program code for automatically re-allocating to computer memory the frequently accessed speech segments.

12. The computer program product of claim 10, wherein said computer usable program code for re-allocating to computer memory the frequently accessed speech segments comprises computer usable program code for manually re-allocating to computer memory the frequently accessed speech segments.

13. The computer program product of claim 9, wherein said computer usable program code for partitioning the speech segments between the computer memory and the data storage unit depending upon their frequency of use comprises:
computer usable program code for assigning a time offset value for each speech segment, the time offset value corresponding to the average time between speech segment access occurrences;
computer usable program code for determining a partition cutoff; and
computer usable program code for comparing the time offset associated with the speech segment with the partition cutoff value, such that if the time offset value of the speech segment is greater than the partition cutoff value, partitioning the desired speech segment in the data storage unit, otherwise partitioning the desired speech segment in the memory unit.

14. The computer program product of claim 10, wherein the frequency usage cutoff value is related to the capacity of the computer memory.

15. A system for dynamically allocating speech segments used in a concatenative text-to-speech engine, the system comprising:
a computer, the computer including:
a memory unit;
a data storage unit adapted to store at least one file containing a plurality of speech segments; and
a processor for sorting the speech segments based upon their frequency of access during speech synthesis, the processor adapted to allocate the frequently used speech segments to the memory unit.

16. The system of claim 15, further including a frequency usage cutoff value and a usage frequency value associated with each speech segment, whereby during speech synthesis, the processor determines whether a desired speech segment resides in the memory unit or the data storage unit by comparing the desired speech segment's usage frequency value with the frequency usage cutoff value.

17. The system of claim 15, wherein the processor re-allocates a speech segment stored in the data storage unit to the memory unit if the speech segment is accessed frequently during speech synthesis.

18. The system of claim 17, wherein the re-allocation of the speech segment stored in the data storage unit to the memory unit is performed automatically.

19. The system of claim 17, wherein the re-allocation of the speech segment stored in the data storage unit to the memory unit is performed manually.

20. The system of claim 16, wherein the frequency usage cutoff value is related to the capacity of the computer memory.
